(19) United States
(12) Patent Application Publication
(10) Pub. No.: US 2004/0040255 A1
(43) Pub. Date: Mar. 4, 2004

(54) Building method and structure

(76) Inventor: Robert Geoffrey Burness, Gaven (AU)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/235,592

(22) Filed: Sep. 4, 2002

(51) Int. Cl. E06B 3/54; E04B 9/00; E04B 1/00; E04G 21/00; E04G 23/00

(52) U.S. Cl. 52/745.09; 52/474

(57) ABSTRACT

A method of building a structure includes the step of mounting a number of support posts on a substrate in a spaced apart, substantially upright orientation, so that at least one floor area is bounded by the support posts. An upper support means is mounted on operatively upper end portions of the support posts. At least one panel is positioned between consecutive support posts. The panels are fixed in position between the support posts. The method includes the step of arranging the support posts and the upper support means so that substantially all load bearing functions are performed by the support posts and upper support means. A structure erected in accordance with said method is also claimed.

### BACKGROUND OF THE DESCRIPTION

1. Field of the Invention

This invention relates to building. More particularly, this invention relates to a method of building a structure and to a structure erected by the method.

1. Discussion of the Background Art

Many conventional building techniques require the use of panel structures. However, in many cases, such panel structures perform load-bearing functions and this places limitations on their design. An example of such a limitation is the necessity for cladding which serves to seal the panels and to provide insulation.

### SUMMARY OF THE INVENTION

The applicant has found that it is possible to provide a means whereby suitable panels can be used in such a way that cladding is unnecessary. The applicant has found that this can be achieved by providing suitable building components, apart from the panels, to perform load-bearing functions. This allows the panels to be provided in a suitable configuration to perform their conventional role and the role of cladding.

### DISCLOSURE OF THE INVENTION

According to a first aspect of the invention, there is provided a method of building a structure, said method including the steps of:

mounting a number of support posts on a substrate in a spaced apart, substantially upright orientation, so that at least one floor area is bounded by the support posts;

mounting an upper support means on operatively upper end portions of the support posts;

positioning at least one panel between consecutive support posts; and

fixing the panels in position between the support posts, the method including the step of arranging the support posts and the upper support means so that substantially all load bearing functions are performed by the support posts and upper support means.

The method may include the steps of forming a footing corresponding with each support post and mounting an operatively lower end portion of each support post in the footing. The support posts are preferably vertical.

A slab may be formed within the floor area defined by the support posts. The slab may be formed to be positioned on each footing. A rebate may be formed in a periphery of the slab.

In one embodiment, the method may include the step of forming the slab so that each support post extends through the slab and into its respective footing. In particular, the method may include the step of forming the slab so that each support post extends through the slab at the rebate.

In another embodiment, the method may include the steps of mounting a stub member in the footing, forming the slab so that the stub member extends through the slab, and mounting the support post on the stub member. In particular, the method may include the step of forming the slab so that each stub member extends through the slab at the rebate.

A lower edge of each panel may be positioned in the rebate, between consecutive support posts. A base element may be positioned in the rebate and each panel may be fastened to the base element.

The method may include the step of sealing a region defined between each side of each support post and an edge of a panel adjacent the support post.

At least two panels may be positioned between each support post. Adjacent edges of the at least two panels may be sealingly fastened together.

Floor support beams may be fastened to the support posts at a position intermediate the upper and lower end portions of the support posts. The method may include supporting a floor structure on the floor support beams.

According to a second aspect of the invention, there is provided a structure erected in accordance with the method described above.

Each support post may be of steel. Each support post may be of any suitable cross sectional shape. In one embodiment, each support post may be tubular and may have a substantially rectangular cross section.

Each panel may be of a cementitious, primary building material. Each panel may instead, or in addition, be of an expanded primary building material.

The upper support means may be in the form of a number of Z-beams, which are positioned on the upper portions of the support posts to span the support posts.

### BRIEF DESCRIPTION OF THE DRAWINGS

A method of building a structure and a structure in accordance with the invention may manifest themselves in a number of different forms. It will be convenient hereinafter to describe, in detail, preferred embodiments of the invention with reference to the accompanying drawings. The purpose of this specific description is to instruct persons having an interest in the subject matter of the invention how to carry the invention into practical effect. It is to be clearly understood, however, that the specific nature of this description does not supersede the generality of the preceding broad disclosure. In the accompanying drawings:

FIG. 1 shows a schematic, three dimensional view of a support post arrangement of a first embodiment of a structure, in accordance with the invention.

FIG. 2 shows a schematic, three-dimensional view of a support post arrangement of a second embodiment of the structure.

FIG. 3 shows a side view of a footing of the structure.

FIG. 4 shows a front view of a footing of the structure.

FIG. 5 shows a three dimensional view of a corner of the structure.

FIG. 6 shows a three dimensional view of an inner wall of the structure.

FIG. 7 shows a schematic side view of a wall of the structure.

FIG. 8 shows a schematic front view of a wall of the structure shown built on a sloping substrate.

FIG. 9 shows a schematic view of the structure at an opening in an outer wall of the structure.

FIG. 10 shows a schematic view of an under eaves bulkout of the structure.

FIG. 11 shows a schematic view of standard eaves of the structure.

FIG. 12 shows a cross sectioned plan view of a support post between a pair of adjacent panels of the structure.

FIG. 13 shows a schematic three-dimensional exploded view of a wall of the structure.

FIG. 14 shows a series of alternative sections of roof beams of the structure.

FIG. 15 shows a series of alternative sections of support posts of the structure.

FIG. 16 shows one embodiment of a fastening arrangement for fastening the panels to a slab of the structure.

FIG. 17 shows another embodiment of a fastening arrangement for fastening the panels to a slab of the structure.

### DESCRIPTION OF EMBODIMENT OF THE INVENTION

A structure, in accordance with a preferred embodiment of the invention and built according to a preferred method of the invention includes a number of support posts 10.

Each support post 10 is of steel. It is to be appreciated that the applicant envisages that the support post may be of any suitably strong material, such as aluminium or, possibly, some other high strength composite. In this particular example, each support post 10 has a substantially rectangular cross section. However, it is to be appreciated that each support post 10 can have a number of different cross sections, some of which are indicated in FIG. 15.

In use, the support posts 10 are mounted on a substrate in a spaced apart, substantially upright orientation so that the support posts 10 bound a floor area 12. In the embodiment the support posts are vertical.

An upper support means in the form of a number of roof support beams 14 are mounted on upper portions 16 of the support posts 10. In this particular example, the beams 14 are in the form of Z-beams. However, as shown in FIG. 14, the beams 14 can take a number of different forms, depending on their particular application and the requirements and preferences of a builder.

A concrete slab 18 is formed in the floor area 12. The concrete slab 18 defines a rebate 20 in a periphery 22 of the slab 18. A base element 24 in the form of a length of angle iron is positioned in each rebate.

A lower end portion 26 of each support post 10 is fastened to the base element 24. This can occur in a number of different ways.

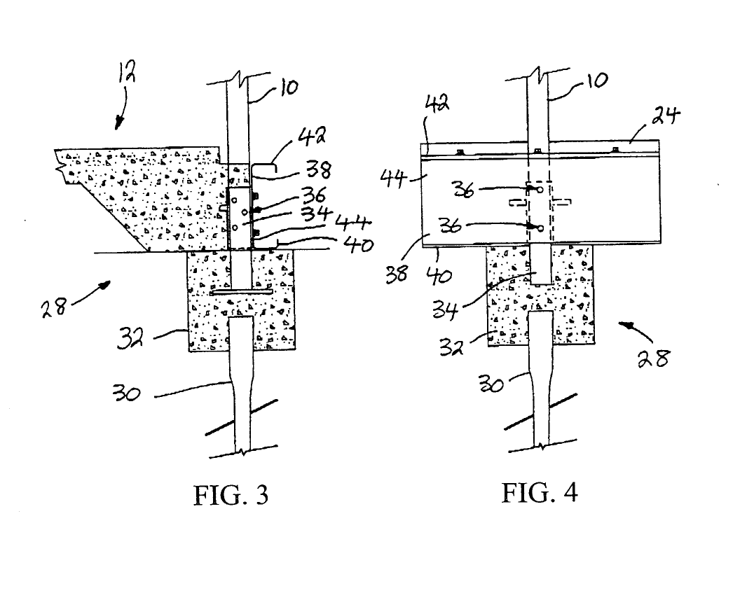

FIGS. 3 and 4 show an example of a footing 28 used with this particular example. Prior to the slab 18 being formed, the footing 28 is constructed for each support post 10. A screw pier 30 is initially positioned in the ground. A concrete block 32 is formed about each pier 30. The concrete block 32 can be of any suitable shape. A starter post 34 is positioned in each concrete block 32, to extend upwardly from the concrete block 32.

The slab 18 is then formed above the footings 28, about the starter posts 34.

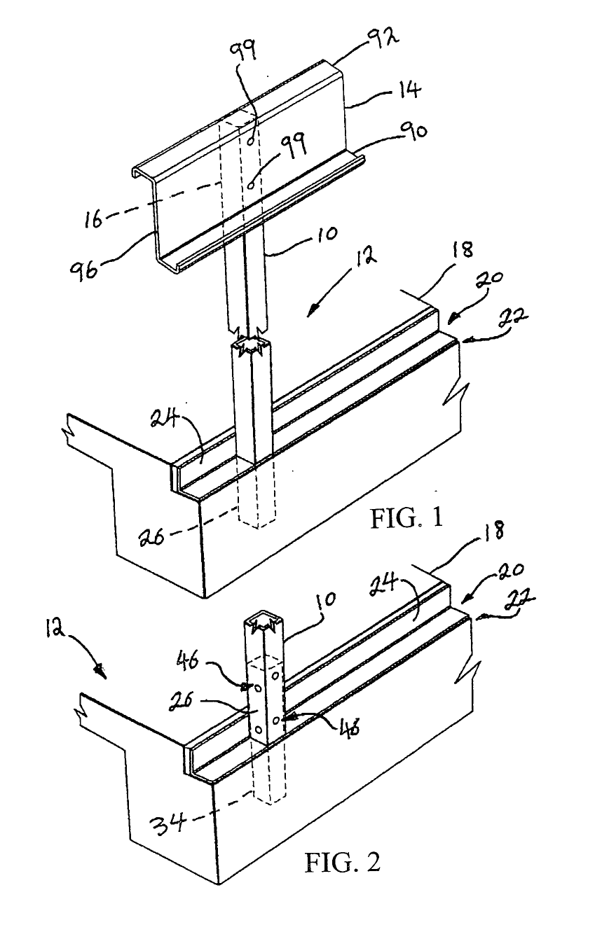

FIG. 1 shows a schematic diagram of one manner in which each support post 10 can be arranged on the slab 18. In this embodiment, the lower end portion 29 of each support post 10 extends through the slab 18 to engage a respective starter post 34. The footing 28 shown in FIGS. 3 and 4 is suited for this embodiment. As can be seen in these drawings, the starter post 34 and the lower portion 26 of the respective support post 10 have corresponding openings 36 to permit the lower portion 26 to be fastened to the starter post 34 with screw fasteners.

A C channel 38 is fastened to the support post 10 and the starter post 34. A lower flange 40 bears against the concrete block 32, while an upper flange 42 is aligned with the rebate 20. A web 44 of the C channel 38 is fastened to both the support post 10 and the starter post 34.

In the embodiment shown in FIG. 2, each starter post 34 extends through the slab 18 to engage a respective support post 10. In this embodiment, the lower end portion 26 and the starter post 34 have corresponding openings 46 to permit the lower end portion 26 and the starter post 34 to be fastened together with suitable screw fasteners.

The structure includes a plurality of panels 48. Each panel 48 is of a lightweight material. In this particular example, each panel is of a lightweight cementitious material. For example, each panel 48 can be in the form of autoclaved, aerated concrete. It is to be appreciated, however, that each panel 48 can be of any other suitable primary material such as an expanded plastics material. An example of such a material is polystyrene.

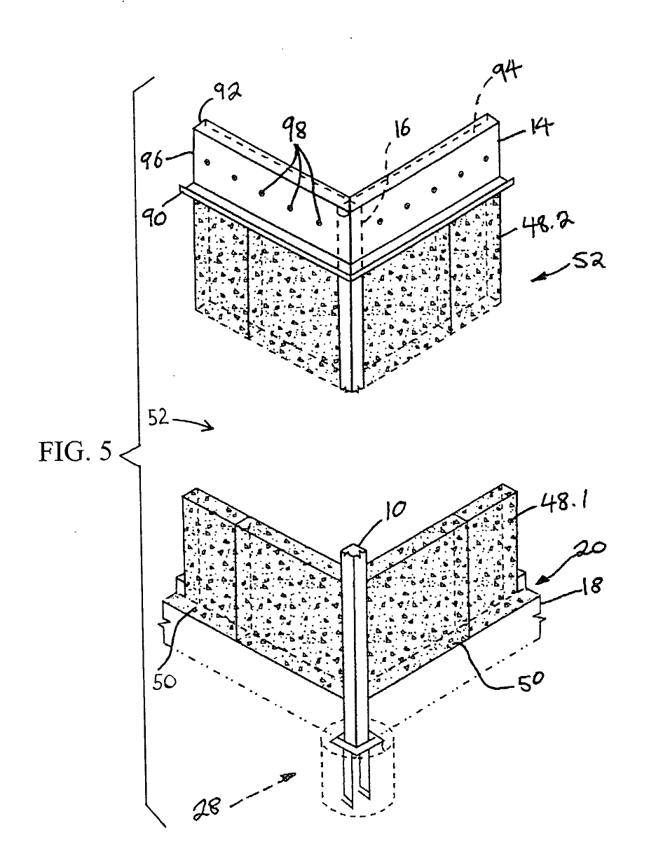

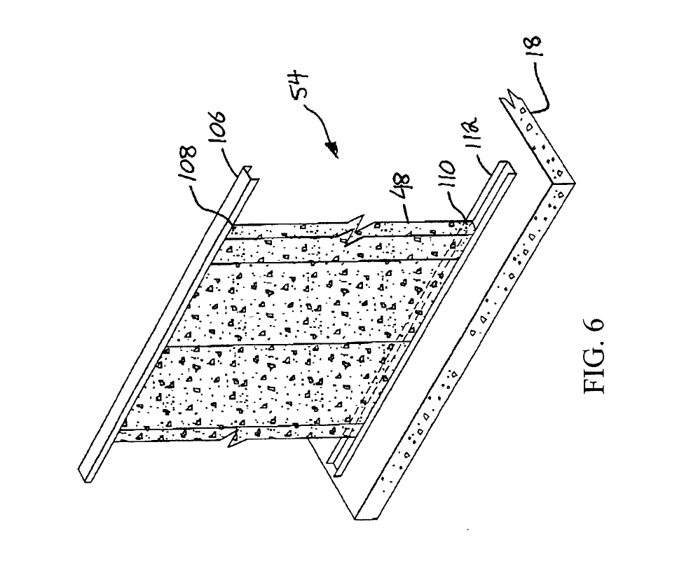

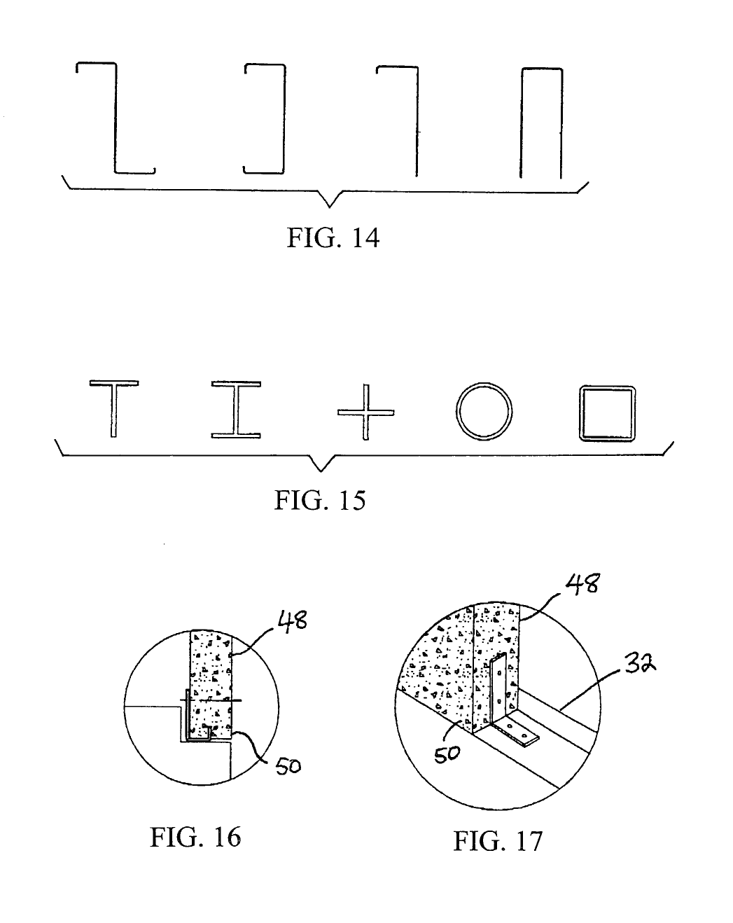

A lower edge 50 of each panel 48 is positioned on the base element 24. The lower edge 50 of each panel 48 can be fastened to the base element 24 in a number of different ways, two of which are shown in FIGS. 16 and 17. FIG. 5 shows the panels 48 as defining outer walls 52 of the structure. On the other hand, FIG. 6 shows the panels 48 defining inner walls 54 of the structure. Each panel 48 is rectangular in the embodiment.

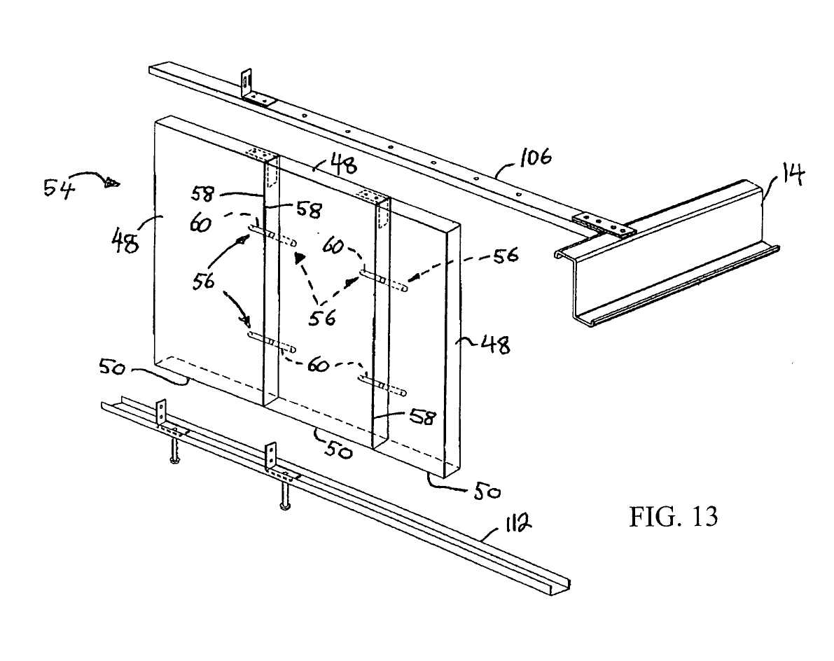

In addition to being fastened to the base element 24, the panels 48 are fastened to each other as shown in FIG. 13. Corresponding holes 56 are formed in adjacent edges 58 of the panels 48, so that adjacent holes 56 are aligned. A dowel member 60 extends into each pair of corresponding holes 56. Suitable sealing material is positioned between the adjacent edges 58.

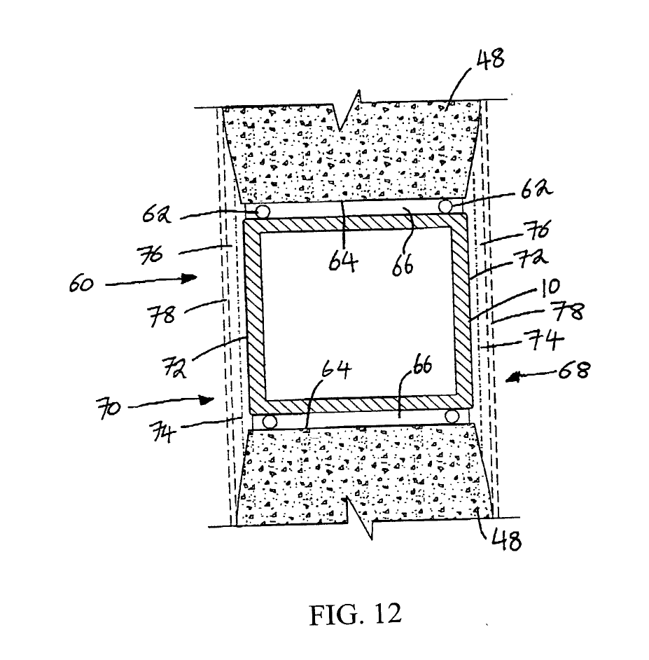

FIG. 12 shows a region 60 of the structure where a pair of panels 48 is positioned on each side of a support post 10. A pair of backing rods 62 are positioned between each side 64 of a panel 48 and the support post 10. The backing rods 62 provide a desired spacing between the support post 10 and the panels 48 on each side of the support post 10. A resultant gap between the support post 10 and each side 62 of the panels 48 is filled with polyurethane filler 66.

A thermal shield coating 72 is provided on each support post 10. Further, a layer of heavy-duty woven fibreglass mesh 74 is positioned on inner and outer sides 68, 70 of the region 60. Thin bed adhesive filler 76 is positioned on the fibreglass mesh 74. An architectural coating 78 is positioned on the adhesive filler 76.

It follows that a high strength connection is defined between the panels 48 at each support post 10.

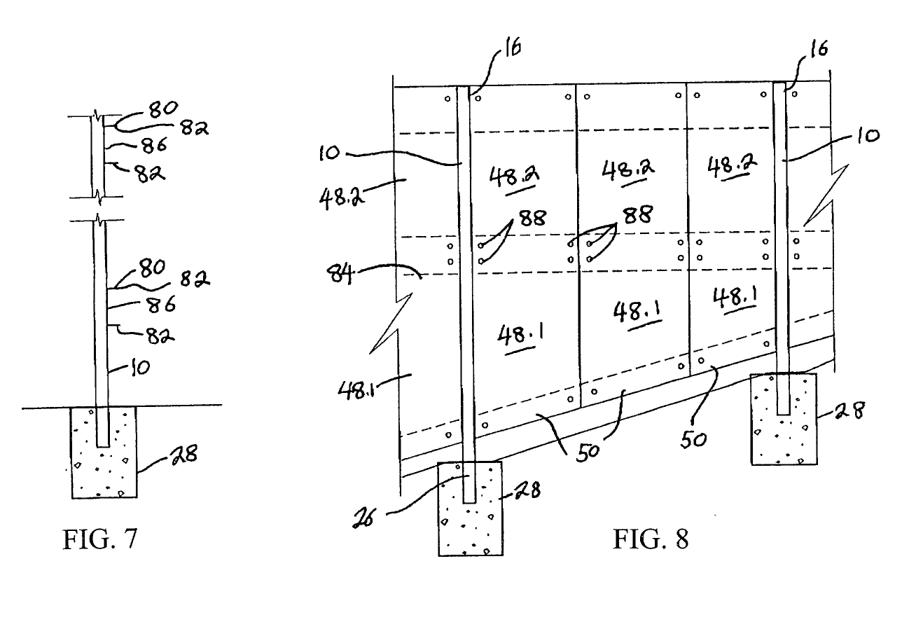

FIGS. 7 and 8 show part of the structure in a multi-storey configuration. A length of C-section 80 is mounted on the support posts 10, intermediate the upper and lower end portions 16, 26 of the support posts 10. The C-section 80 is dimensioned so that an intermediate floor structure (not shown) can be received between flanges 82 of the C-section 80.

In this case, upper edges 84 of lower panels 48.1 are fastened to a web 86 of the C-section 80. Fastening elements used for this purpose are indicated at 88 in FIG. 8.

The Z-beams 14 are positioned on the outer walls 52 of the structure. The Z-beams 14 are positioned so that a lower flange 90 of each Z-beam 14 is directed outwardly, and an upper flange 92 is directed inwardly. An upper portion 94 of each upper panel 48.2 is fastened to an inner side of a web 96 of each Z-beam. This is achieved by bugle head batten screws 98 internally fixed through the panels 48.2 to the web 96. Further, the upper portions 16 of the support posts 10 are fixed to the web 96 with fasteners indicated at 99.

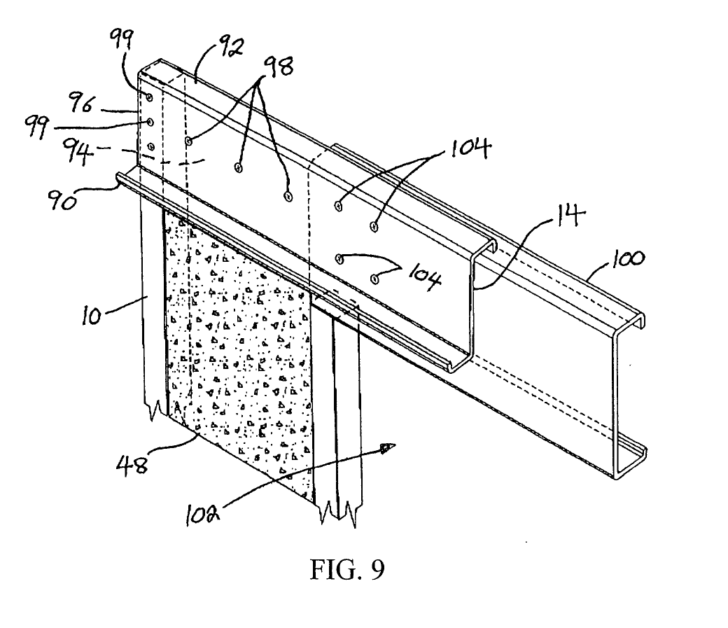

It will, of course, be appreciated that it is necessary to have openings in the outer walls 52 for windows, doors etc. An example of a configuration suitable for a door or a window is shown in FIG. 9. Here, a length of C-section 100 is positioned over the Z-beam 14 to span an opening indicated at 102. Suitable fasteners 104 are provided for fastening the C-section 100 to the Z-beam 14.

One of the inner walls 54 is shown in FIG. 6. Instead of the Z-beams, the panels 48 defining such inner walls 54 have a length of channel steel 106 positioned on upper edges 108 of those panels 48. The channel steel 106 is positioned to extend between the Z-beams 14. An example of this is shown in FIG. 13.

Lower edges 110 of these panels 48 are fastened within base channel members 112 positioned on the slab 18.

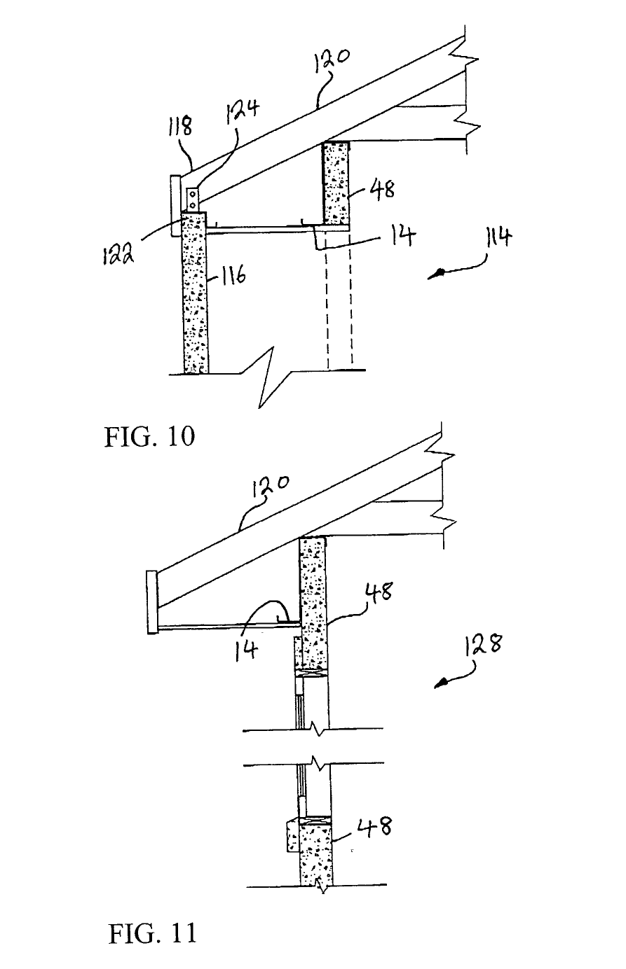

FIGS. 10 and 11 show two different embodiments of eaves of the structure.

FIG. 10 shows an under eaves bulkout 114. In this embodiment further panels 116 are provided and are spaced outwardly from the panel 48. The further panels 116 are substantially the same as the panels 48.

Lower ends 118 of roof trusses 120 are connected to an upper edge 122 of each panel 116. Angle brackets 124 are fixed to the lower ends 118 of the roof trusses. A Z-beam 126 is connected to the upper edge 122 of each panel 116. The angle brackets 124 are connected to the Z-beams 126. FIG. 11 shows standard eaves 128.

It will be appreciated that the structure described above discloses a point loading system for the structure. The reason for this is that substantially all load bearing functions are performed by the support posts 10 and the Z-beams 14. This allows the panels 48 to perform substantially only insulation functions. The panels 48 also perform some cross-bracing functions.

The fact that the structure uses a point loading system facilitates the erection of the structure on a slope as shown in FIG. 8. As a result of the fact that the panels do not carry any load, uneven stresses on the panels 48 as a result of the structure being built on the slope is avoided.

The point loading arrangement defined by the structure described above also allows a roof structure to be erected prior to the panels 48 being positioned.

An advantage of the invention is that there are substantially less components used with the erection of the structure than are presently used with the erection of similar structures. This facilitates off-site fabrication of the various components and delivery to the site where they are erected to form the structure. Thus, ordering of components for building projects via a medium such as the World Wide Web is facilitated.

A particular advantage of the invention is the fact that the panels 48 can be configured to perform insulating functions. The reason for this is that the panels do not have to be configured to perform load-bearing functions. This obviates the need for cladding and therefore increases the speed of building and lowers the cost of building.

It is to be understood that the above embodiments have been provided only by way of exemplification of this invention, and that further modifications and improvements thereto, as would be apparent to persons skilled in the relevant art, are deemed to fall within the broad scope and ambit of the present invention as set out in the claims which follow.

I claim:

1. A method of building a structure, said method comprising the steps of:
mounting a number of support posts on a substrate in a spaced apart, substantially upright orientation, so that at least one floor area is bounded by the support posts;
mounting an upper support means on operatively upper end portions of the support posts;
positioning at least one panel between consecutive support posts; and
fixing the panels in position between the support posts, the method including the step of arranging the support posts and the upper support means so that substantially all load bearing functions are performed by the support posts and upper support means.

2. The method, as claimed in claim 1, which further comprises the steps of:
forming a footing corresponding with each support post; and mounting an operatively lower end portion of each support post in the footing.

3. The method as claimed in claim 1, which further comprises the step of forming a slab within the floor area defined by the support posts, so that the slab is positioned on each footing.

4. The method as claimed in claim 3, which further comprises the step of forming a rebate in a periphery of the slab.

5. The method as claimed in claim 4, which further comprises the step of forming the slab so that each support post extends through the slab and into its respective footing.

6. The method as claimed in claim 5, which further comprises the step of forming the slab so that each support post extends through the slab at the rebate.

7. The method as claimed in claim 4, which further comprises the steps of mounting a stub member in the footing, forming the slab so that the stub member extends through the slab, and mounting the support post on the stub member.

8. The method as claimed in claim 7, which further comprises the step of forming the slab so that each stub member extends through the slab at the rebate.

9. The method as claimed in claim 4, which further comprises the step of positioning a lower edge of each panel in the rebate, between consecutive support posts.

10. The method as claimed in claim 9, which further comprises the steps of positioning a base element in the rebate and fastening each panel to the base element.

11. The method as claimed in claim 1, which further comprises the step of sealing a region defined between each side of each support post and an edge of a panel adjacent the support post.

12. The method as claimed in claim 1, which further comprises the steps of:
positioning at least two panels between each support post; and sealingly fastening adjacent edges of the at least two panels together.

13. The method as claimed in claim 1, which further comprises the step of fastening floor support beams to the support posts at a position intermediate the upper and lower end portions of the support posts.

14. The method as claimed in claim 1, which further comprises the step of supporting a floor structure on the floor support beams.

15. A structure produced by a method comprising the steps of:
mounting a number of support posts on a substrate in a spaced apart, substantially upright orientation, so that at least one floor area is bounded by the support posts;
mounting an upper support means on operatively upper end portions of the support posts;
positioning at least one panel between consecutive support posts; and
fixing the panels in position between the support posts, the method including the step of arranging the support posts and the upper support means so that substantially all load bearing functions are performed by the support posts and upper support means.

16. The structure as claimed in claim 15, in which each support post is of steel.

17. The structure as claimed in claim 16, in which each support post is tubular and has a substantially rectangular cross section.

18. The structure as claimed in claim 15, in which each panel is composed of a cementitious primary building material.

19. The structure as claimed in claim 15, in which each panel is composed of an expanded primary building material.

20. The structure as claimed in claim 15, in which the upper support means is in the form of a number of Z-beams, which are positioned on the upper portions of the support posts to span the support posts.
